(19) United States
(12) Patent Application Publication
(10) Pub. No.: US 2010/0021063 A1
(43) Pub. Date: Jan. 28, 2010

(54) Digital photo frame with automatic image recognition, display system and method thereof

(75) Inventor: Tsung-Yu Yang, Taipei County (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., Taipei County (TW)

(21) Appl. No.: 12/285,482

(22) Filed: Oct. 7, 2008

(30) Foreign Application Priority Data
Jul. 25, 2008 (TW) 097128461

(51) Int. Cl. G06K 9/46; H04N 5/228

(52) U.S. Cl. 382/190; 348/222.1

(57) ABSTRACT

A digital photo frame with automatic image recognition, a display system, and a method thereof is related to the digital photo frame including an image capturing unit, a storage unit, an image recognition unit, a comparison unit, and a display unit. First, the image capturing unit captures an image data of a object, and the storage unit stores a plurality of image data. Next, the image recognition unit recognizes a feature corresponding to the object in the captured image data, and the comparison unit searches for at least one image data having the recognized feature in the plurality of image data stored in the storage unit according to the recognized feature. Finally, the display unit displays the at least one image data obtained by searching.

### CROSS-REFERENCE TO RELATED APPLICATIONS

This non-provisional application claims priority under 35 U.S.C. § 119(a) on Patent Application No(s). 097128461 filed in Taiwan, R.O.C. on Jul. 25, 2008, the entire contents of which are hereby incorporated by reference.

### BACKGROUND

1. Field of Invention

The present invention relates to a display device and a display method thereof, and more particularly to a digital photo frame with automatic image recognition, a display system, and a method thereof.

2. Related Art

Recently, digital photo frames are becoming increasingly popular in the market. The digital photo frame provides users with another platform for viewing and storing digital photos or films in addition to the computer, and the image quality and appearance thereof are improved rapidly. In order to further increase the product competitiveness, it is necessary to reduce the production cost and develop new functions to stimulate the sales.

Generally the digital photo frame has an image playing function, and enables the user to store or play the digital photos and films via a built-in firmware or software. Thereby, the user may view the digital photos and films without using a personal computer, so it is quite convenient in use.

However, the common digital photo frame does not have a shooting lens, and may only be able to play the originally stored digital photos or films, such that the user has to manually select the image data to be played, and the desired image data cannot be automatically recognized and played on the digital photo frame.

Moreover, in order to increase the product competitiveness, the operation of the digital photo frame must be made more convenient. Therefore, if the digital photo frame develops toward automation, the practicability thereof will be further improved.

### SUMMARY OF THE INVENTION

Accordingly, the present invention is directed to a digital photo frame with automatic image recognition, a display system, and a method thereof, so as to solve the problem in the prior art that a user has to manually select the image data to be played, and it is impossible to automatically recognize and play the desired image data by the digital photo frame.

A digital photo frame with automatic image recognition includes an image capturing unit, a storage unit, an image recognition unit, a comparison unit, and a display unit.

The image capturing unit is used to capture an image data of an object. The storage unit is used to store a plurality of image data. The image recognition unit is used to recognize at least one feature corresponding to the object in the captured image data. The comparison unit is used to search for at least one image data having the recognized feature in the plurality of image data stored in the storage unit according to the recognized feature. The display unit is used to display the at least one image data obtained by searching.

In addition, the digital photo frame further includes a connection port electrically connected to the image capturing unit, for receiving and providing the image data captured by the image capturing unit to the image recognition unit.

Further, the image recognition unit and the comparison unit are at least one microprocessor. The comparison unit searches for the at least one image data having the same feature as the recognized one in the stored plurality of image data.

A display method with automatic image recognition includes the following steps. First, an image data of an object is captured. Next, at least one feature corresponding to the object in the captured image data is recognized. Then, a plurality of image data stored in a database is searched according to the feature. Afterward, at least one image data having the recognized feature in the stored plurality of image data is obtained. Finally, the obtained at least one image data is displayed.

The searching step includes searching for at least one image data having the same feature as the recognized one in the plurality of image data. The obtaining step includes obtaining the at least one image data having the same feature as the recognized one.

To sum up, in the present invention, the image data of an object is automatically captured by the image capturing unit. Then, the feature of the image data is recognized and analyzed by the image recognition unit and the comparison unit. After that, at least one image data having the same feature as the recognized one in the storage unit is searched for according to the feature, and finally the obtained at least one image data is displayed. Therefore, the image data desired by the user can be automatically recognized and played, such that the present invention is more convenient in use, and the manual operation becomes unnecessary.

### BRIEF DESCRIPTION OF THE DRAWINGS

The present invention will become more fully understood from the detailed description given herein below for illustration only, and thus are not limitative of the present invention, and wherein:

FIG. 1 is a block diagram of a digital photo frame with automatic image recognition according to an embodiment of the present invention;

FIG. 2 is a block diagram of a digital photo frame with automatic image recognition according to an embodiment of the present invention;

FIG. 3 is a schematic view of a digital photo frame with automatic image recognition according to an embodiment of the present invention;

FIG. 4 is a schematic view of an application of a display method with automatic image recognition according to an embodiment of the present invention; and

FIG. 5 is a flow chart of a display method with automatic image recognition according to an embodiment of the present invention.

### DETAILED DESCRIPTION OF THE INVENTION

The detailed features and advantages of the present invention will be described in detail in the following embodiments. Those skilled in the arts can easily understand and implement the content of the present invention. Furthermore, the relative objectives and advantages of the present invention are apparent to those skilled in the arts with reference to the content disclosed in the specification, claims, and drawings. The embodiments below are intended to further describe the views of the present invention instead of limiting the scope of the same.

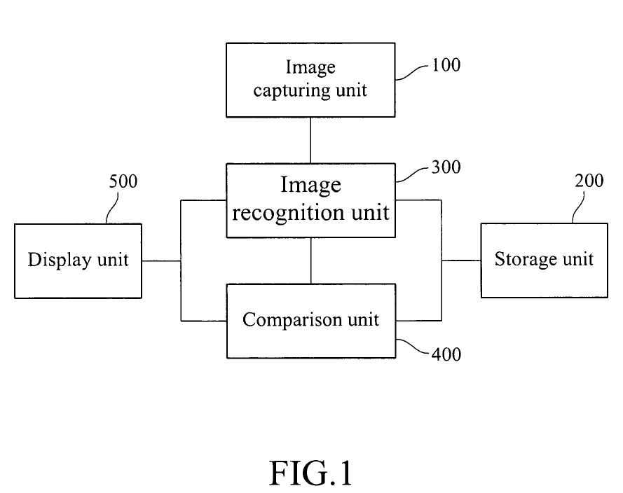

FIG. 1 is a block diagram of a digital photo frame with automatic image recognition according to an embodiment of the present invention.

Referring to FIG. 1, the digital photo frame with automatic image recognition includes an image capturing unit 100, a storage unit 200, an image recognition unit 300, a comparison unit 400, and a display unit 500.

The image capturing unit 100 is electrically connected to the image recognition unit 300 and the comparison unit 400. The storage unit 200 is electrically connected to the image recognition unit 300 and the comparison unit 400. The display unit 500 is electrically connected to the image recognition unit 300 and the comparison unit 400.

The image capturing unit 100 captures an image data of an object. The storage unit 200 stores a plurality of image data. The image recognition unit 300 recognizes a feature corresponding to the object in the captured image data. The comparison unit 400 searches for at least one image data having the correspondingly recognized feature in the plurality of image data stored in the storage unit 200 according to the recognized feature. The display unit 500 displays the at least one image data obtained by searching.

For example, when an object (for example, a user or any object) stands in front of the image capturing unit 100 (for example, a shooting lens or a camera), the image capturing unit 100 captures an image data (for example, a digital photo or a film) of the object. After receiving the image data of the object, the image recognition unit 300 begins to recognize at least one feature (for example, the contour, positions of five sense organs, skin color, or the shape of the object) corresponding to the object in the captured image data. Then, the comparison unit 400 searches for at least one image data having the recognized feature in the plurality of image data stored in the storage unit 200 (for example, a database or a memory) according to the recognized feature, and obtains a plurality of image data. Finally, the display unit 500 (for example, a screen) displays the at least one image data obtained by searching. The above process may be performed via a software or firmware.

The image capturing unit 100 is built in or externally connected.

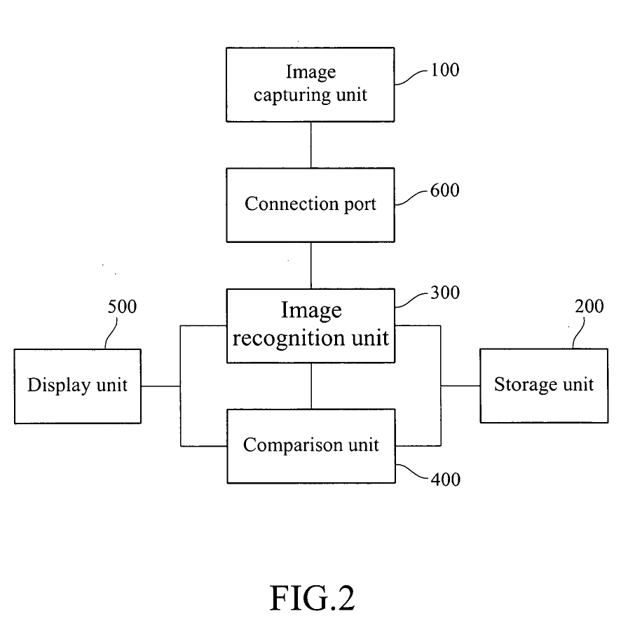

FIG. 2 is a block diagram of a digital photo frame with automatic image recognition according to an embodiment of the present invention

Referring to FIG. 2, this embodiment further includes a connection port 600 electrically connected to the image capturing unit 100, for receiving and providing the image data captured by the image capturing unit 100 to the image recognition unit 300.

That is, the image capturing unit 100 (for example, an externally connected camera) is externally connected via the connection port 600. Here, the display unit 500 is a computer screen, and the image capturing unit 100 is connected to an information processing device through the connection port 600, such that the computer screen connected to the information processing device may display the corresponding image data. The information processing device includes, but not limited to, a desktop computer, a portable computer, a personal digital assistant (PDA), a cellular phone, and other devices capable of independently gathering, analyzing, and processing information.

In addition, in another embodiment, the connection port 600 is disposed in the digital photo frame with automatic image recognition. That is, the digital photo frame with automatic image recognition may be externally connected to the image capturing unit 100 (for example, an externally connected camera) via the connection port 600.

Here, the connection port 600 may be selectively a universal serial bus (USB), and this is only an exemplary description instead of limiting the implementation aspect of the present invention.

Further, the image recognition unit 300 and the comparison unit 400 may be at least one microprocessor. The comparison unit 400 searches for at least one image data having the same feature as the recognized one in the stored plurality of image data.

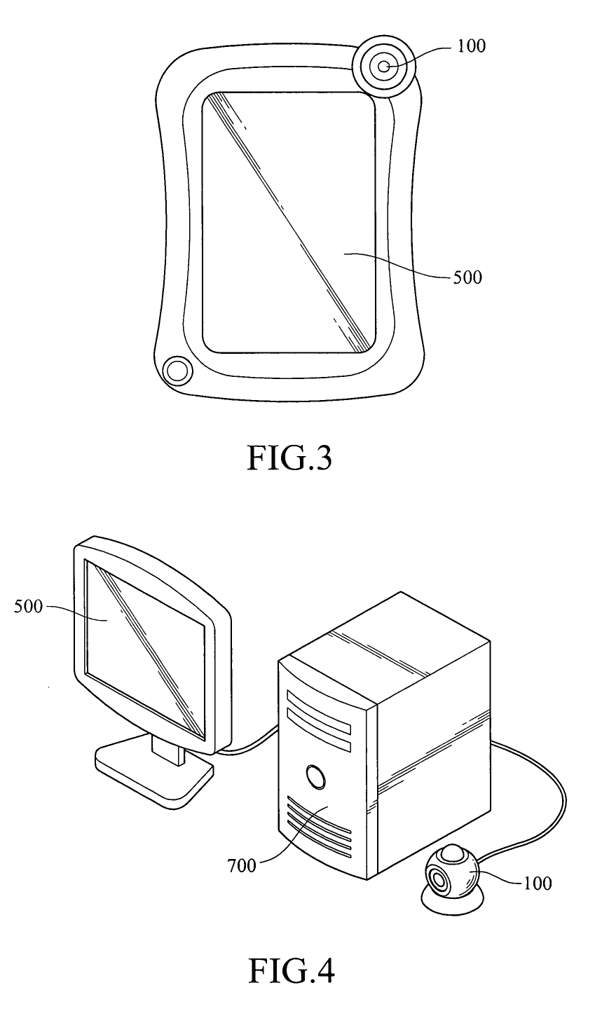

FIG. 3 is a schematic view of a display system with automatic image recognition according to an embodiment of the present invention. As shown in FIG. 3, this embodiment includes an image capturing unit 100, a storage unit (not shown), an image recognition unit (not shown), a comparison unit (not shown), and a display unit 500. In addition, the image capturing unit 100 may be a built-in camera.

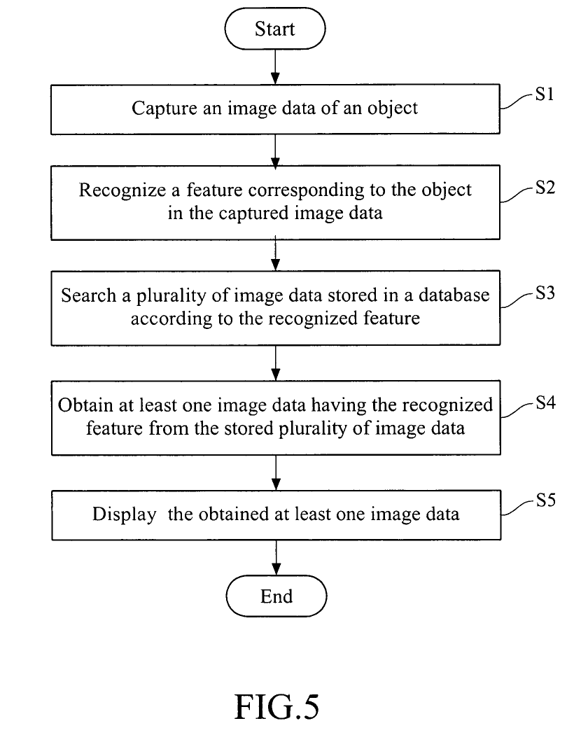

FIG. 4 is a schematic view of an application of a display method with automatic image recognition according to an embodiment of the present invention. As shown in FIG. 4, this embodiment includes an image capturing unit 100, an information processing device 700, a display unit 500, and a connection port 600. The image capturing unit 100 is electrically connected to the information processing device 700 through the connection port 600, such that the computer screen connected to the information processing device may display the corresponding image data.

A display method with automatic image recognition according to an embodiment of the present invention will be further described below.

Referring to FIG. 5, a flow chart of a display method with automatic image recognition according to an embodiment of the present invention is shown.

In FIG. 5, the display method with automatic image recognition includes the following steps. First, an image data of an object is captured (Step S1). Next, a feature corresponding to the object in the captured image data is recognized (Step S2). Then, a plurality of image data stored in a database is searched according to the recognized feature (Step S3). Afterward, at least one image data having the recognized feature is obtained from the stored plurality of image data (Step S4). Finally, the obtained at least one image data is displayed (Step S5).

A detailed description is given as follows. First, when an object (for example, a user) stands in front of the image capturing unit 100 (for example, a shooting lens or a camera), the image capturing unit 100 automatically captures an image data (for example, a digital photo or a film) of the object (Step S1). After receiving the image data of the object, the image recognition unit 300 begins to recognize a feature (for example, the contour, positions of five sense organs, skin color, or the shape of the object) corresponding to the object in the captured image data (Step S2). Then, the comparison unit 400 searches for a plurality of image data corresponding to the recognized feature of the object in the plurality of image data stored in the storage unit 200 (for example, a database or a memory) according to the recognized feature (Step S3), and obtains at least one image data having the recognized feature in the stored plurality of image data (Step S4). Finally, the display unit 500 (for example, a screen) displays the at least one image data obtained by searching (Step S5). In addition, the plurality of image data is displayed on one frame after being contracted. The above process may be performed via a software or firmware.

The searching step (S3) includes searching for at least one image data having the same feature as the recognized one in the plurality of image data. The obtaining step (S4) includes obtaining the at least one image data having the same feature as the recognized one. When the feature (for example, the contour, positions of five sense organs, skin color, or the shape of the object) of the captured image data of the object cannot be recognized, or after the recognition, it is impossible to search for the at least one image data having the recognized feature in the storage unit 200 (for example, a database), the display unit 500 continues to maintain the originally displayed frame, and may not automatically alter the displayed image data.

In an embodiment of the present invention, an application of an electronic photo frame is given below for description. The electronic photo frame may store digital photos or films of a user by the storage unit 200. The image capturing unit 100 of the electronic photo frame shoots the user, to capture the image data of the user. On receiving the captured image data of the user, the image recognition unit 300 immediately and automatically begins to recognize the feature of the image data. When the feature recognition is finished, and it is obtained that the feature of the image data is an image block corresponding to the user, the comparison unit 400 searches the image data pre-stored in the storage unit 200 (for example, the digital photos or films stored in the storage unit 200) according to the feature, so as to obtain the image data having the image block of the user from the stored image data. After that, the display unit 500 displays the digital photos or films having the image block of the user obtained by searching on the frame. If the user does not have any digital photo stored in the storage unit 200, the display unit 500 continues to maintain the originally displayed frame or displays the captured image.

In view of the above, according to the present invention, the image data of an object is automatically captured by the image capturing unit 100. Then, the feature of the image data is recognized and analyzed by the image recognition unit 300 and the comparison unit 400. After that, at least one image data having the same feature as the recognized one in the storage unit 200 is searched for according to the feature, and finally the obtained at least one image data is displayed. Therefore, the captured image (image data) can be automatically recognized, and the image data relative to the captured image is displayed, such that the present invention is more convenient in use, and the manual operation becomes unnecessary. It should be noted that, the system applying the method of the present invention includes, but not limited to, a desktop computer, a portable computer, a PDA, and a cellular phone.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A digital photo frame with automatic image recognition, comprising:
an image capturing unit, for capturing an image data of an object;
a storage unit, for storing a plurality of image data;
an image recognition unit, for recognizing at least one feature corresponding to the object in the captured image data;
a comparison unit, for searching the plurality of image data in the storage unit according to the recognized feature, so as to obtain the image data with the feature; and
a display unit, for displaying the image data with the feature obtained by searching.

2. The digital photo frame with automatic image recognition according to claim 1, further comprising a connection port, electrically connected to the image capturing unit, for receiving and providing the image data captured by the image capturing unit to the image recognition unit.

3. The digital photo frame with automatic image recognition according to claim 1, wherein the image recognition unit and the comparison unit are at least one microprocessor.

4. The digital photo frame with automatic image recognition according to claim 1, wherein the comparison unit searches for at least one image data having the same feature as the recognized one in the stored plurality of image data.

5. A display method with automatic image recognition, comprising:
capturing an image data of an object by an image capturing device;
recognizing at least one feature corresponding to the object in the captured image data;
searching a plurality of image data stored in a database according to the feature;
obtaining the image data with the feature in the stored plurality of image data; and
displaying the obtained image data by a display device.

6. The display method with automatic image recognition according to claim 5, wherein the searching step comprises searching for at least one image data having the same feature as the recognized one in the plurality of image data.

7. The display method with automatic image recognition according to claim 6, wherein the obtaining step comprises obtaining the at least one image data having the same feature as the recognized one.

8. A display system with automatic image recognition, comprising:
a information processing device, connected to a display unit and an image capturing unit for capturing an image data of an object, the information processing device further comprising:
a storage unit, for storing a plurality of image data;
an image recognition unit, for recognizing at least one feature corresponding to the object in the captured image data; and
a comparison unit, for searching the plurality of image data in the storage unit according to the recognized feature, so as to obtain the image data with the feature,
wherein the display unit displays the image data with the feature obtained by searching.

9. The display system with automatic image recognition according to claim 8, wherein the information processing device is respectively externally connected to the display unit and the image capturing unit.

10. The display system with automatic image recognition according to claim 9, wherein the information processing device is at least one selected from a group consisting of a desktop computer, a portable computer, a personal digital assistant (PDA), and a cellular phone.

11. The display system with automatic image recognition according to claim 8, wherein the information processing device is at least one selected from a group consisting of a desktop computer, a portable computer, a personal digital assistant (PDA), and a cellular phone.
